(19) United States
(12) Patent Application Publication
(10) Pub. No.: US 2026/0071698 A1
(43) Pub. Date: Mar. 12, 2026

(54) ASSEMBLY STRUCTURE AND PROTECTOR

(71) Applicant: Yazaki Corporation, Tokyo (JP)

(72) Inventor: Hiroyuki NISHI, Tochigi (JP)

(73) Assignee: Yazaki Corporation, Tokyo (JP)

(21) Appl. No.: 19/317,305

(22) Filed: Sep. 3, 2025

(30) Foreign Application Priority Data
Sep. 6, 2024 (JP) 2024-153753

(51) Int. Cl. F16L 3/13; F16B 2/22

(52) U.S. Cl. CPC F16L 3/13; F16B 2/22

(57) ABSTRACT

A first assembly member has an orthogonal wall provided with an orthogonal flat face, a through hole provided in the orthogonal wall, a partition wall as a first locking part sectioning the through hole into a first through hole and a second through hole, and a protruding part caused to protrude from the orthogonal flat face. A second assembly member has a contact wall causing a tip to be in contact with the orthogonal flat face of a first periphery.

The present application claims priority to and incorporates by reference the entire contents of Japanese Patent Application No. 2024-153753 filed in Japan on September 6, 2024.

### BACKGROUND OF THE INVENTION

### 1. Field of the Invention

The present invention relates to an assembly structure and a protector.

### 2. Description of the Related Art

Conventionally, a protector in which two assembly members are assembled, and a harness body is passed through the inner space between them is known. This protector is provided with a locking mechanism in order to maintain the two assembly members in an assembly completion position. The locking mechanism maintains the two assembly members in the assembly completion position by locking a first locking part provided in one assembly member and a second locking part provided in the other assembly member to each other. This protector is disclosed, for example, in Japanese Patent Application Laid-open No. 2000-120933 and Japanese Patent Application Laid-open No. 2011-36005.

By the way, as the locking mechanism, for example, as in the protector in Japanese Patent Application Laid-open No. 2000-120933, a flexible part having flexibility provided between two through holes is used as the first locking part, and a claw at the tip of the second locking part inserted into one of the two through holes is hooked onto the flexible part, thereby locking the first locking part and the second locking part to each other. In this type of locking mechanism, the first locking part is flexed by the claw while inserting the second locking part into the one through hole, and when the claw sticks out the one through hole, the flexural deformation of the first locking part is released, thereby placing the claw in a position where it can be hooked onto the first locking part. The other through hole is provided as an escape space for the first locking part to allow flexural deformation of the first locking part. In the protector in Japanese Patent Application Laid-open No. 2000-120933, a cover plate for preventing incorrect insertion is covered over the other through hole so that the second locking part does not enter the other through hole incorrectly. However, in the locking mechanism, the second locking part may also be made flexible, in which case the flexibly deformed second locking part may be guided into the other through hole.

### SUMMARY OF THE INVENTION

Given these circumstances, an object of the present invention is to provide an assembly structure and a protector that can contribute to preventing incorrect insertion of a locking mechanism.

An assembly structure according to one aspect of the present invention includes a first assembly member; a second assembly member assembled to the first assembly member; and a locking mechanism maintaining the first assembly member and the second assembly member in an assembly completion position by a first locking part provided in the first assembly member and a second locking part provided in the second assembly member being locked to each other, wherein the first assembly member has an orthogonal wall provided with an orthogonal flat face with respect to an assembly direction of the second assembly member, a through hole provided in the orthogonal wall, a partition wall sectioning the through hole into a first through hole and a second through hole, and a protruding part caused to protrude from the orthogonal flat face, a periphery of the through hole in the orthogonal wall has a first periphery spaced apart from and facing the partition wall closer to the first through hole, a second periphery spaced apart from and facing the partition wall closer to the second through hole, a third periphery coupled to the first periphery and the partition wall, and a fourth periphery spaced apart from and facing the third periphery to be coupled to the first periphery and the partition wall, the first through hole is formed in a rectangular shape surrounded by the first periphery, the partition wall, the third periphery, and the fourth periphery, the second assembly member has a main body, and a contact wall erected from the main body in the assembly direction and causing a tip to be in contact with the orthogonal flat face of the first periphery in the assembly completion position, the locking mechanism utilizes the partition wall having flexibility as the first locking part, the second locking part has a locking piece, having a fixed end closer to the contact wall, caused to protrude in the assembly direction and inserted into the first through hole in the assembly completion position, and a locking claw provided at a free end of the locking piece sticking out the first through hole in the assembly completion position, and hooked onto the first locking part to be locked in the assembly completion position, and the protruding part is caused to protrude from the orthogonal flat face closer to the second through hole than the first through hole in the third periphery, and locking the tip of the contact wall when the second locking part is inserted into the second through hole to float the second assembly member compared to when the second locking part is inserted into the first through hole.

A protector according to another aspect of the present invention includes a housing member housing a harness body through an opening; a cover member assembled to the housing member to cover the opening; and a locking mechanism maintaining the housing member and the cover member in an assembly completion position by a first locking part provided in the housing member and a second locking part provided in the cover member being locked to each other, wherein the housing member has an orthogonal wall provided with an orthogonal flat face with respect to an assembly direction of the cover member, a through hole provided in the orthogonal wall, a partition wall sectioning the through hole into a first through hole and a second through hole, and a protruding part caused to protrude from the orthogonal flat face, a periphery of the through hole in the orthogonal wall has a first periphery spaced apart from and facing the partition wall closer to the first through hole, a second periphery spaced apart from and facing the partition wall closer to the second through hole, a third periphery coupled to the first periphery and the partition wall, and a fourth periphery spaced apart from and facing the third periphery to be coupled to the first periphery and the partition wall, the first through hole is formed in a rectangular shape surrounded by the first periphery, the partition wall, the third periphery, and the fourth periphery, the cover member has a main body covering the opening, and a contact wall erected from the main body in the assembly direction and causing a tip to be in contact with the orthogonal flat face of the first periphery in the assembly completion position, the locking mechanism utilizes the partition wall having flexibility as the first locking part, the second locking part has a locking piece, having a fixed end closer to the contact wall, caused to protrude in the assembly direction and inserted into the first through hole in the assembly completion position, and a locking claw provided at a free end of the locking piece sticking out the first through hole in the assembly completion position, and hooked onto the first locking part to be locked in the assembly completion position, and the protruding part is caused to protrude from the orthogonal flat face closer to the second through hole than the first through hole in the third periphery, and locking the tip of the contact wall when the second locking part is inserted into the second through hole to float the cover member compared to when the second locking part is inserted into the first through hole.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of the principal parts of an assembly structure and a protector of an embodiment, illustrating a locking mechanism when it is inserted properly;

FIG. 2 is a top view of the principal parts of the assembly structure and the protector of the embodiment, illustrating the locking mechanism when it is inserted properly;

FIG. 3 is a side view of the principal parts of the assembly structure and the protector of the embodiment, illustrating the locking mechanism when it is inserted properly;

FIG. 4 is an exploded perspective view of the principal parts of the assembly structure and the protector of the embodiment;

FIG. 5 is a perspective view for describing a housing member;

FIG. 6 is a perspective view of the principal parts of the assembly structure and the protector of the embodiment, illustrating the locking mechanism when it is inserted incorrectly; and

FIG. 7 is a side view of the principal parts of the assembly structure and the protector of the embodiment, illustrating the locking mechanism when it is inserted incorrectly.

### DETAILED DESCRIPTION OF THE PREFERRED EMBODIMENTS

An embodiment of an assembly structure and a protector according to the present invention will be described below in detail based on the accompanying drawings. Note that this embodiment does not limit this invention.

### Embodiment

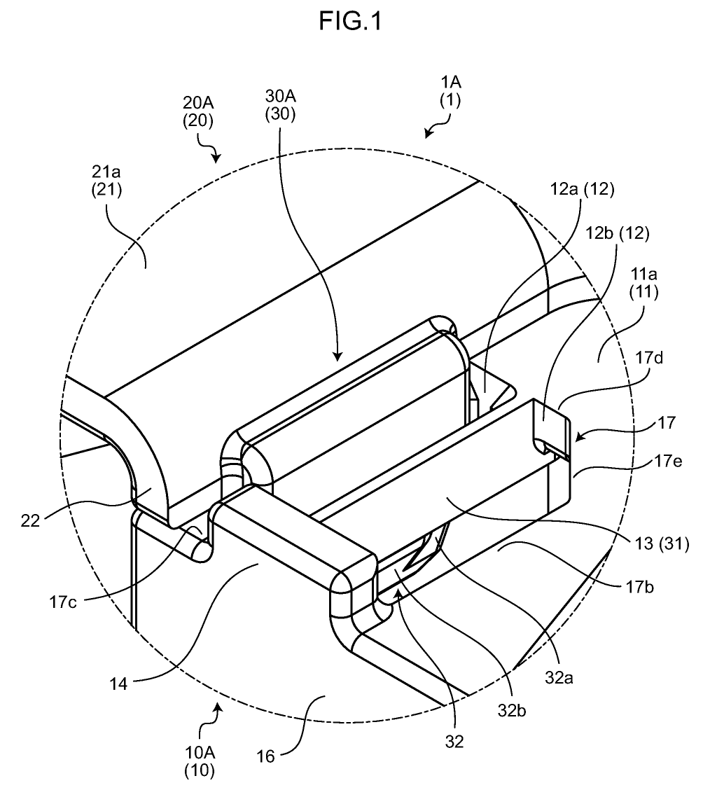

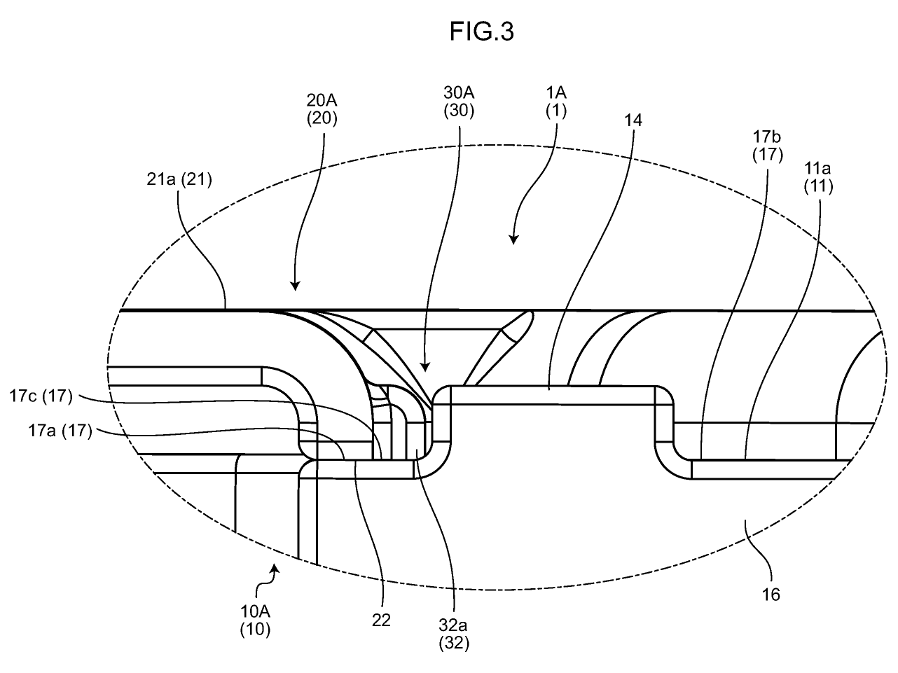

One embodiment of the assembly structure and the protector according to the present invention will be described based on FIG. 1 to FIG. 7.

The sign 1 in FIG. 1 to FIG. 4 indicates the assembly structure of the present embodiment. This assembly structure 1 includes a first assembly member 10, a second assembly member 20 assembled to the first assembly member 10, and a locking mechanism 30 maintaining the first assembly member 10 and the second assembly member 20 in an assembly completion position (FIG. 1 to FIG. 4). Examples of this assembly structure 1 include a protector 1A housing part of a harness body (not shown) inside and protecting it from its surroundings (FIG. 1 to FIG. 4). This protector 1A includes a housing member 10A as the first assembly member 10 housing the harness body through an opening 10a, and a cover member 20A as the second assembly member 20 assembled to this housing member 10A to cover the opening 10a (FIG. 1 to FIG. 4). This protector 1A includes a locking mechanism 30A maintaining the housing member 10A and the cover member 20A in the assembly completion position (FIG. 1 to FIG. 4).

The housing member 10A (the first assembly member 10) has an orthogonal wall 11 provided with an orthogonal flat face 11a with respect to an assembly direction of the cover member 20A (the second assembly member 20) (FIG. 1 to FIG. 4). This housing member 10A (first assembly member 10) has a through hole 12 provided in the orthogonal wall 11, a partition wall 13 sectioning the through hole 12 into a first through hole 12a and a second through hole 12b, and a protruding part 14 caused to protrude from the orthogonal flat face 11a of the orthogonal wall 11 (FIG. 1 to FIG. 4). The partition wall 13 is formed in a straight-line shape having flexibility capable of being flexibly deformed toward the first through hole 12a and toward the second through hole 12b.

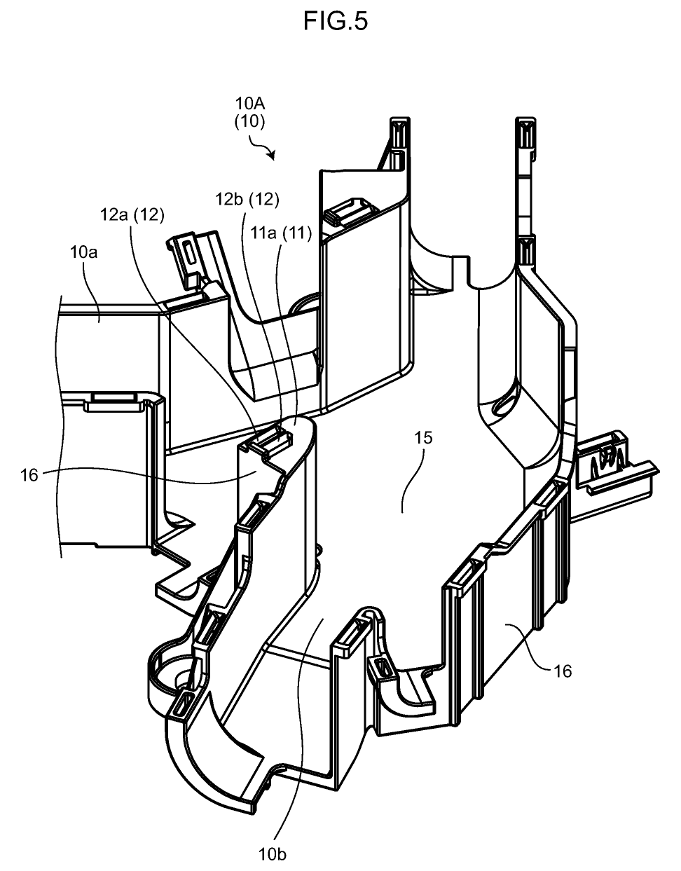

For example, the housing member 10A has a bottom wall 15 and a pair of side walls 16 forming a housing chamber 10b along a routing path of the harness body (FIG. 5). The pair of side walls 16 are cantilevered walls that are spaced apart from each other and erected from the bottom wall 15. In the housing member 10A, between the respective free ends of this pair of side walls 16 is the opening 10a of the housing chamber 10b. In this housing member 10A, the orthogonal wall 11 having the orthogonal flat face 11a orthogonal to the erected direction of the side walls 16 is provided in the form of connecting to the free end of one side wall 16 (FIG. 5).

A periphery 17 of the through hole 12 in the orthogonal wall 11 has a first periphery 17a spaced apart from and facing the partition wall 13 closer to the first through hole 12a, a second periphery 17b spaced apart from and facing the partition wall 13 closer the second through hole 12b, a third periphery 17c coupled to the first periphery 17a and the partition wall 13, and a fourth periphery 17d spaced apart from and facing the third periphery 17c to be coupled to the first periphery 17a and the partition wall 13 (FIG. 1 to FIG. 4).

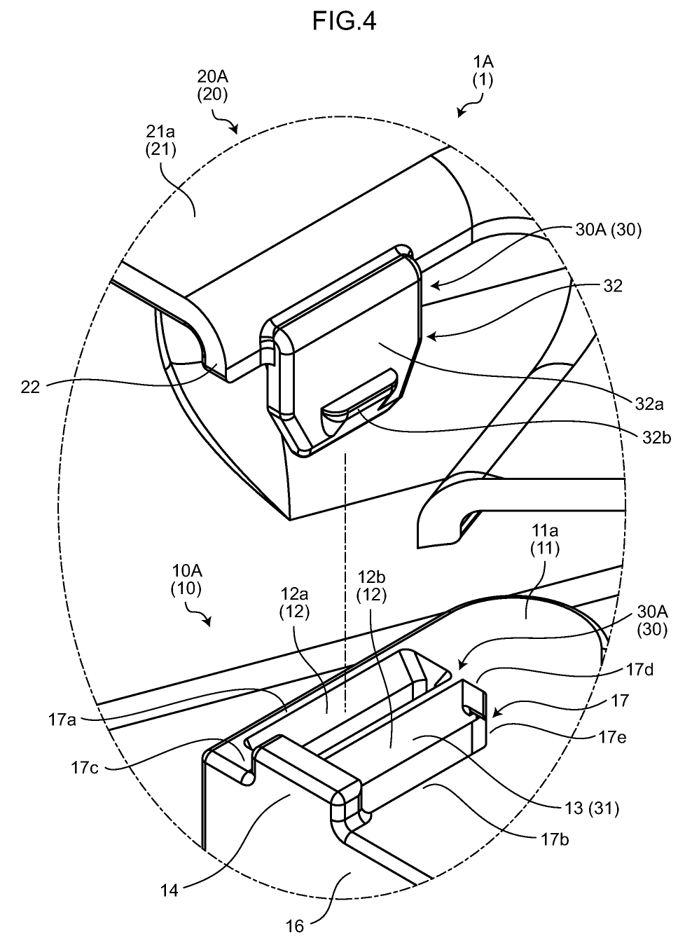

In the orthogonal wall 11, the first periphery 17a and the second periphery 17b are formed in a straight-line shape parallel to the straight-line partition wall 13 (FIG. 4). In this orthogonal wall 11, the third periphery 17c and the fourth periphery 17d are formed in a straight-line shape in the form of being orthogonal to the first periphery 17a, the second periphery 17b, and the partition wall 13 (FIG. 4). Thus, the first through hole 12a is formed in a rectangular shape surrounded by the first periphery 17a, the partition wall 13, the third periphery 17c, and the fourth periphery 17d.

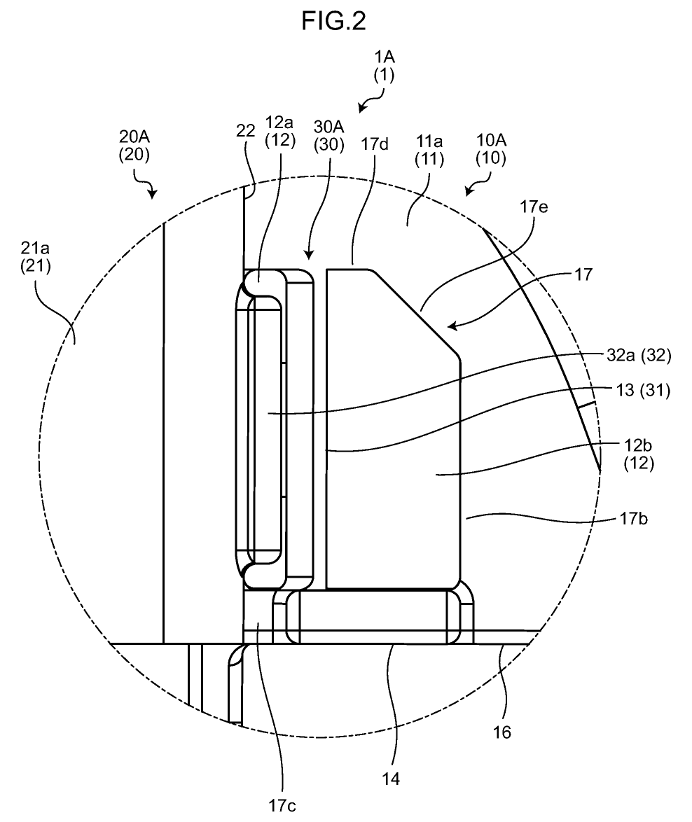

Note that the third periphery 17c illustrated in this example is provided at the free end of one side wall 16 in the housing member 10A. The periphery 17 of the through hole 12 illustrated in this example has a fifth periphery 17e coupling the second periphery 17b and the third periphery 17c to each other and diagonally connecting the second periphery 17b and the fourth periphery 17d to each other (FIG. 1, FIG. 2, and FIG. 4).

The cover member 20A (the second assembly member 20) has a main body 21, and a contact wall 22 erected from this main body 21 in the assembly direction with respect to the housing member 10A (the first assembly member 10) and causing a tip to be in contact with the orthogonal flat face 11a of the first periphery 17a in the assembly completion position with the housing member 10A (the first assembly member 10) (FIG. 1 to FIG. 4). In the cover member 20A, the main body 21 blocks the opening 10a of the housing member 10A.

The main body 21 has a flat plate part 21a that is parallel to the orthogonal wall 11 at least around the orthogonal wall 11 when in the assembly completion position (FIG. 1 to FIG. 4). The contact wall 22 is caused to protrude from this flat plate part 21a in a flat plate shape with a uniform amount of protrusion.

The locking mechanism 30A (the locking mechanism 30) is provided in the protector 1A (the assembly structure 1), for example, as one of the same type of locking mechanisms 30A (locking mechanisms 30) in several locations or one of several types of locking mechanisms in several locations. This locking mechanism 30A (locking mechanism 30) includes a first locking part 31 provided in the housing member 10A (the first assembly member 10) and a second locking part 32 provided in the cover member 20A (the second assembly member 20) (FIG. 1 to FIG. 4). This locking mechanism 30A (locking mechanism 30) maintains the housing member 10A (the first assembly member 10) and the cover member 20A (the second assembly member 20) in the assembly completion position by the first locking part 31 and the second locking part 32 being locked to each other.

This locking mechanism 30A (locking mechanism 30) utilizes the partition wall 13 having flexibility as the first locking part 31.

The second locking part 32 has a locking piece 32a, having a fixed end closer to the contact wall 22, caused to protrude in the assembly direction of the cover member 20A (the second assembly member 20) and inserted into the first through hole 12a in the assembly completion position of the housing member 10A (the first assembly member 10) and the cover member 20A (the second assembly member 20) (FIG. 1 to FIG. 4). This locking piece 32a is formed in a cantilever shape having a fixed end closer to the outer wall surface side of the contact wall 22 and also formed in a flat plate shape parallel to the contact wall 22, being caused to protrude beyond the tip of this contact wall 22. This locking piece 32a allows its free end to stick out the first through hole 12a in the assembly completion position.

The second locking part 32 has a locking claw 32b provided at the free end of the locking piece 32a sticking out the first through hole 12a in the assembly completion position, and hooked onto the first locking part 31 to be locked in the assembly completion position (FIG. 1 and FIG. 4). This locking claw 32b is caused to protrude from a flat face on the free end of the locking piece 32a.

In this locking mechanism 30A (locking mechanism 30), when the cover member 20A (the second assembly member 20) is assembled to the housing member 10A (the first assembly member 10), the second locking part 32 is inserted into the first through hole 12a from the free end of the locking piece 32a, and the locking claw 32b at its free end flexes the first locking part 31 toward the second through hole 12b. In this locking mechanism 30A (locking mechanism 30), when the cover member 20A (the second assembly member 20) reaches the assembly completion position with respect to the housing member 10A (the first assembly member 10), the free end of the locking piece 32a sticks out the first through hole 12a together with the locking claw 32b, and the flexural deformation of the first locking part 31 is released. As a result, in this locking mechanism 30A (locking mechanism 30), when the second locking part 32 moves to be pulled out of the first through hole 12a, the locking claw 32b is hooked onto the first locking part 31. Therefore, this locking mechanism 30A (locking mechanism 30) can maintain the housing member 10A (the first assembly member 10) and the cover member 20A (the second assembly member 20) in the assembly completion position.

This locking mechanism 30A (locking mechanism 30) is provided with the second through hole 12b adjacent to the first through hole 12a in order to flexibly deform the first locking part 31 along with the insertion of the second locking part 32 into the first through hole 12a. Therefore, in this locking mechanism 30A (locking mechanism 30), the second locking part 32 may be inserted incorrectly into the second through hole 12b. The protruding part 14 is provided in order to prevent the incorrect insertion of the second locking part 32.

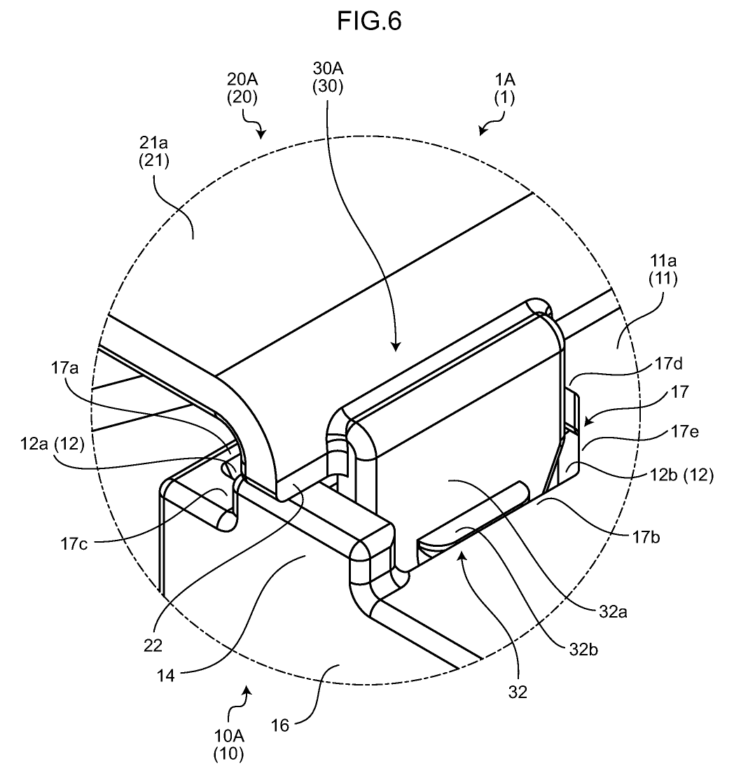

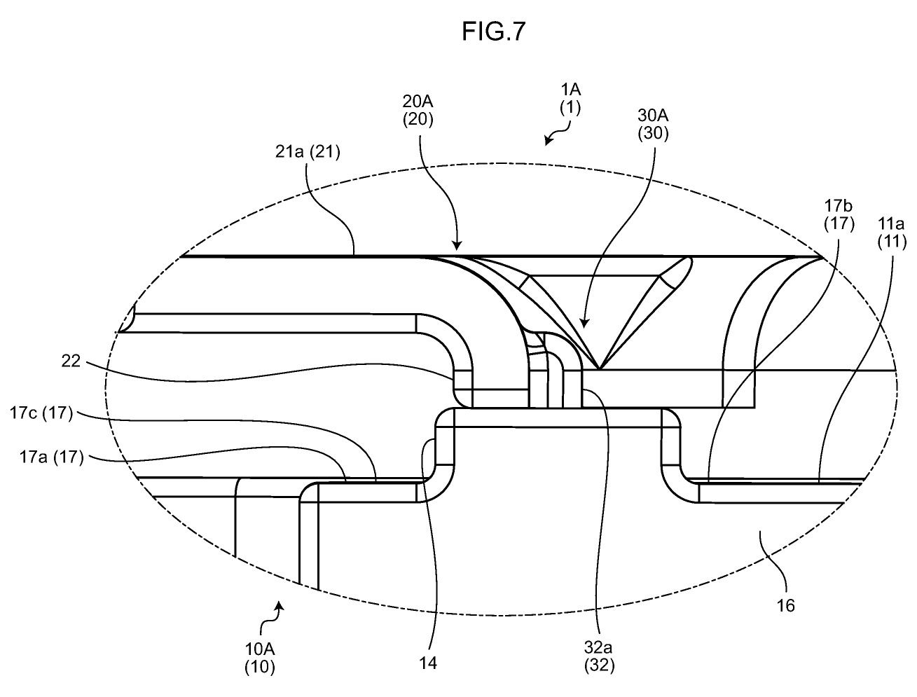

The protruding part 14 is caused to protrude from the orthogonal flat face 11a closer to the second through hole 12b than the first through hole 12a in the third periphery 17c (FIG. 1 to FIG. 4). This protruding part 14 locks the tip of the contact wall 22 when the second locking part 32 is inserted into the second through hole 12b to float the cover member 20A (the second assembly member 20) compared to when the second locking part 32 is inserted into the first through hole 12a (FIG. 6 and FIG. 7). Therefore, the protruding part 14 is caused to protrude, in the orthogonal flat face 11a of the third periphery 17c, from the part adjacent to the partition wall 13 to the part positioned on the periphery of the second through hole 12b.

For example, when assembling the cover member 20A (the second assembly member 20) to the housing member 10A (the first assembly member 10), a worker views the floating of the cover member 20A (the second assembly member 20), and can thereby grasp the fact that in the locking mechanism 30A (the locking mechanism 30), the second locking part 32 has been inserted incorrectly into the second through hole 12b. Thus, the protruding part 14 is caused to protrude to a height at which the floating of the cover member 20A (the second assembly member 20) is visible when locking the tip of the contact wall 22. For example, the protruding part 14 is caused to protrude at a height that leaves a large gap between the orthogonal flat face 11a of the orthogonal wall 11 in the housing member 10A (the first assembly member 10) and the cover member 20A (the second assembly member 20).

By the way, the second locking part 32 is disposed in the second through hole 12b with a gap against the periphery of the second through hole 12b (the partition wall 13, the second periphery 17b, the third periphery 17c, and the fourth periphery 17d) when it is inserted incorrectly. Therefore, the protruding part 14 and the contact wall 22 need to adjust their shapes and positions so that they can be locked to each other no matter at what position the second locking part 32 is inserted in the second through hole 12b. For this purpose, the protruding part 14 is extended along the third periphery 17c so as to lock the tip of the contact wall 22 no matter at what position the second locking part 32 is inserted in the second through hole 12b. The contact wall 22 is extended along the main body 21 so as to lock the tip to the protruding part 14 no matter at what position the second locking part 32 is inserted in the second through hole 12b.

As shown above, the protector 1A (the assembly structure 1) of the present embodiment, even if the second locking part 32 is inserted into the incorrect second through hole 12b adjacent to the first through hole 12a, enables the worker or the like to recognize the incorrect insertion of the second locking part 32 by floating the cover member 20A (the second assembly member 20) with the protruding part 14 of the housing member 10A (the first assembly member 10). Thus, the protector 1A (the assembly structure 1) of the present embodiment contributes to preventing incorrect insertion of the locking mechanism 30A (the locking mechanism 30), and even if incorrect insertion of the second locking part 32 occurs, it can guide the worker or the like to reinsert this second locking part 32 into the correct first through hole 12a. Therefore, the protector 1A (the assembly structure 1) of the present embodiment can assemble the housing member 10A (the first assembly member 10) and the cover member 20A (the second assembly member 20) in the proper position. The protector 1A (the assembly structure 1) of the present embodiment enables the worker or the like to recognize this during incorrect insertion of the second locking part 32, thus avoiding situations such as continuing to push the second locking part 32 into the incorrect second through hole 12b and preventing deterioration in the durability of the locking mechanism 30A (the locking mechanism 30).

The protector (the assembly structure) according to the present embodiment, even if the second locking part is inserted into the incorrect second through hole adjacent to the first through hole, enables the worker or the like to recognize the incorrect insertion of the second locking part by floating the cover member (the second assembly member) with the protruding part of the housing member (the first assembly member). Thus, the protector (the assembly structure) according to the present embodiment contributes to preventing incorrect insertion of the locking mechanism, and even if incorrect insertion of the second locking part occurs, it can guide the worker or the like to reinsert the second locking part into the correct first through hole. Therefore, the protector (the assembly structure) according to the present embodiment can assemble the housing member (the first assembly member) and the cover member (the second assembly member) in the proper position.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An assembly structure comprising:
a first assembly member;
a second assembly member assembled to the first assembly member; and
a locking mechanism maintaining the first assembly member and the second assembly member in an assembly completion position by a first locking part provided in the first assembly member and a second locking part provided in the second assembly member being locked to each other, wherein
the first assembly member has an orthogonal wall provided with an orthogonal flat face with respect to an assembly direction of the second assembly member, a through hole provided in the orthogonal wall, a partition wall sectioning the through hole into a first through hole and a second through hole, and a protruding part caused to protrude from the orthogonal flat face,
a periphery of the through hole in the orthogonal wall has a first periphery spaced apart from and facing the partition wall closer to the first through hole, a second periphery spaced apart from and facing the partition wall closer to the second through hole, a third periphery coupled to the first periphery and the partition wall, and a fourth periphery spaced apart from and facing the third periphery to be coupled to the first periphery and the partition wall,
the first through hole is formed in a rectangular shape surrounded by the first periphery, the partition wall, the third periphery, and the fourth periphery,
the second assembly member has a main body, and a contact wall erected from the main body in the assembly direction and causing a tip to be in contact with the orthogonal flat face of the first periphery in the assembly completion position,
the locking mechanism utilizes the partition wall having flexibility as the first locking part,
the second locking part has a locking piece, having a fixed end closer to the contact wall, caused to protrude in the assembly direction and inserted into the first through hole in the assembly completion position, and a locking claw provided at a free end of the locking piece sticking out the first through hole in the assembly completion position, and hooked onto the first locking part to be locked in the assembly completion position, and
the protruding part is caused to protrude from the orthogonal flat face closer to the second through hole than the first through hole in the third periphery, and locking the tip of the contact wall when the second locking part is inserted into the second through hole to float the second assembly member compared to when the second locking part is inserted into the first through hole.

2. The assembly structure according to claim 1, wherein
the protruding part is caused to protrude to a height at which the floating of the second assembly member is visible when locking the tip of the contact wall.

3. The assembly structure according to claim 1, wherein
the protruding part is extended along the third periphery so as to lock the tip of the contact wall no matter at what position the second locking part is inserted in the second through hole, and
the contact wall is extended along the main body so as to lock the tip to the protruding part no matter at what position the second locking part is inserted in the second through hole.

4. The assembly structure according to claim 2, wherein
the protruding part is extended along the third periphery so as to lock the tip of the contact wall no matter at what position the second locking part is inserted in the second through hole, and
the contact wall is extended along the main body so as to lock the tip to the protruding part no matter at what position the second locking part is inserted in the second through hole.

5. A protector comprising:
a housing member housing a harness body through an opening;
a cover member assembled to the housing member to cover the opening; and
a locking mechanism maintaining the housing member and the cover member in an assembly completion position by a first locking part provided in the housing member and a second locking part provided in the cover member being locked to each other, wherein
the housing member has an orthogonal wall provided with an orthogonal flat face with respect to an assembly direction of the cover member, a through hole provided in the orthogonal wall, a partition wall sectioning the through hole into a first through hole and a second through hole, and a protruding part caused to protrude from the orthogonal flat face,
a periphery of the through hole in the orthogonal wall has a first periphery spaced apart from and facing the partition wall closer to the first through hole, a second periphery spaced apart from and facing the partition wall closer to the second through hole, a third periphery coupled to the first periphery and the partition wall, and a fourth periphery spaced apart from and facing the third periphery to be coupled to the first periphery and the partition wall,
the first through hole is formed in a rectangular shape surrounded by the first periphery, the partition wall, the third periphery, and the fourth periphery,
the cover member has a main body covering the opening, and a contact wall erected from the main body in the assembly direction and causing a tip to be in contact with the orthogonal flat face of the first periphery in the assembly completion position,
the locking mechanism utilizes the partition wall having flexibility as the first locking part,
the second locking part has a locking piece, having a fixed end closer to the contact wall, caused to protrude in the assembly direction and inserted into the first through hole in the assembly completion position, and a locking claw provided at a free end of the locking piece sticking out the first through hole in the assembly completion position, and hooked onto the first locking part to be locked in the assembly completion position, and
the protruding part is caused to protrude from the orthogonal flat face closer to the second through hole than the first through hole in the third periphery, and locking the tip of the contact wall when the second locking part is inserted into the second through hole to float the cover member compared to when the second locking part is inserted into the first through hole.
